(19) United States
(12) Patent Application Publication
(10) Pub. No.: US 2014/0328013 A1
(43) Pub. Date: Nov. 6, 2014

(54) Music book

(71) Applicants: Gerald Lee Heikes, Palmer, AK (US); Michael Robert McGaughey, Anchorage, AK (US)

(72) Inventors: Gerald Lee Heikes, Palmer, AK (US); Michael Robert McGaughey, Anchorage, AK (US)

(21) Appl. No.: 13/986,457

(22) Filed: May 5, 2013

(51) Int. Cl. G06F 1/16

(52) U.S. Cl. CPC G06F 1/1647
USPC 361/679.27

(57) ABSTRACT

A portable computer unlike conventional computers in that it has no computer base. It functions as and resembles a book. It has two monitor screens that share the central processing unit, video card, ram, hard drive, and other computer related equipment as needed. Each of the two monitors may display content independently of the other. It's target users are aimed primarily, but not limited to those whose passions lie in music creation, recording, performance and private instruction, as well as school and church choirs and instrumentalists. An example of how this may be used; the system enables a user to view both monitors with a teaching instructor on the left monitor while reading sheet music on the right monitor. When not in use it Folds together one monitor on top of the other for a compact overall configuration suitable for storage and transport.

### FIELD OF THE INVENTION

The present invention relates generally to portable computers, and in particular, to dual monitor laptop type computers.

### BACKGROUND OF THE INVENTION

As computer technology continues to develop laptop computers become more prevalent at the office, home, and school.

One (1) problem commonly associated with portable laptop computers is that they are built with only one monitor.

Various attempts at designing a two monitor laptop may force compromises in ergonomics and versatility. Examples of these attempts can be seen by reference to several U.S. patents.

U.S. Pat. No. 5,168,426, issued in the name of Hoving, et al., describes a hinge mechanism for a portable computer which provides additional range for upward angling of the screen.

U.S. Pat. No. 5,255,214, issued in the name of Ma, describes a portable computer with a level and angular position adjustably display assembly rotatable via a pair of perpendicular supports.

U.S. Pat. No. 5,729,429, issued in the name of Margaritis et al., describes a laptop computer with a plurality of collapsible. display positioning supports which provide a large range of height and positioning configurations.

U.S. Pat. No. 6,229,693, issued in the name of Kardis et al., describes an articulated notebook computer display with locking vertical adjustment and full rotational positioning adjustment capabilities.

U.S. Patent No. D630206.S1, issued in the name of Kovac, describes one smaller computer display coming from inside a larger display.

U.S. Patent No. 20040051679.A1, issued in the name of Ponx, describes a laptop or notebook computer which employs first and second display screens coupled electronically to display identical images at the same time.

While these devices fulfill their respective, particular objectives, each of these references suffer from one (1) or more of the aforementioned disadvantages. Accordingly there exists a need for a portable computer with dual display monitors without the disadvantages as described above.

### SUMMARY OF THE INVENTION

In view of the foregoing references, the inventor recognizes the aforementioned inherent problems and observes that there is a need for a dual screen monitor display for portable computers which provides a minimum range of discrete adjustability while maintaining existing features of collapsibility convenience, and durability.

Thus, the object of the present invention is to solve the aforementioned disadvantages and provide for this need. This invention is aimed primarily, but not limited to those whose passions lie in music creation, recording, performance and private instruction.

Yet still another object of the present invention is ease in opening and using the invention, just like one would open and use a book. The computer construction is different than most others in that its construction is like that of a book consisting of a left side monitor and right side monitor.

Yet still another object of the present invention is that both monitor displays are LED backlit, wireless display ready, touch screens having full high definition 1080p resolution. Control of both display monitors is by a multi-monitor adapter video card with a ribbon cable contained in the hinge bracket.

Yet still another object of the present invention is that the display monitors are equipped with front and back integrated 1080p webcams and microphones.

Further objects and advantages of the present invention will become apparent from a consideration of the drawings and ensuing description.

### BRIEF DESCRIPTION OF THE DRAWINGS

The advantages and features of the present invention will become better understood with reference to the following more detailed description and claims taken in conjunction with accompanying drawings, in which like elements are identified with like symbols, and in which:

FIG. 1 is a perspective front open view; according to the preferred embodiment of the present invention;

FIG. 2 is a perspective back open view; according to the preferred embodiment of the present invention;

FIG. 3 is a perspective front and back closed view; according to the preferred embodiment of the present invention;

FIG. 4 is a perspective top and bottom opened and closed view; according to the preferred embodiment of the present invention;

FIG. 5 is a perspective left and right display monitor outside edge view; according to the preferred embodiment of the present invention.

### DESCRIPTIVE KEY

1 portable computer front
2 portable computer back open view
3 front and back closed view
4 top and bottom open and closed view
5 left and right outside edge view

### DETAILED DESCRIPTION OF THE PREFERRED EMBODIMENT

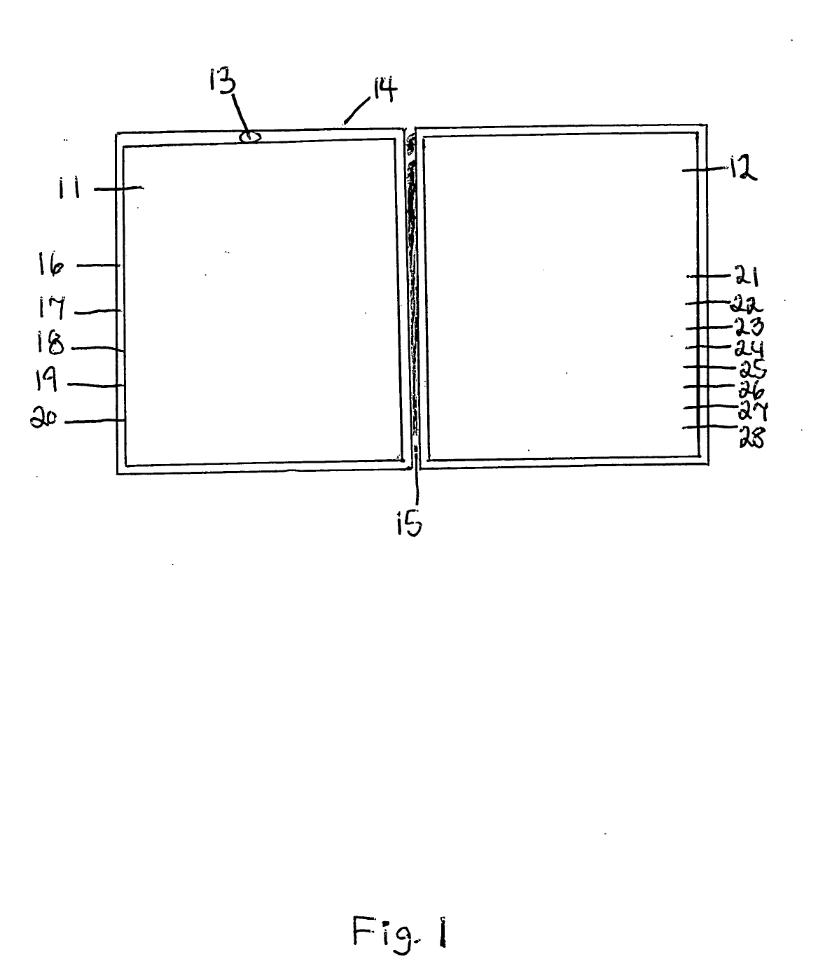

The best mode for carrying out the invention is presented in terms of preferred embodiment, herein depicted within FIGS. 1 through 5. However, the invention is not limited to the described embodiment and a user skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and only one particular configuration will be shown and described for purposes of clarity and disclosure and not by way of limitation of scope.

The present invention describes a dual display monitor computer system (herein described as the “system”) which provides a means for a personal computer with enhanced features. The construction and design departs from earlier designs whereby each of the two monitor housings contains shared computer components; i.e. there is no computer base. Each computer monitor may display content independently of the other

An example of how this may be used; the system enables a user to view both monitors with a teaching instructor on the left monitor while reading sheet music on the right monitor.

Another example of how this may be used; a music teacher is giving private violin lessons to six members of the orchestra located in another classroom. Using her Music Book with the Webcam turned on, the camera transmits her instruction to each of the six members Music Books via WIFI, which if in record mode records the instruction class in real time.

Referring to FIG. 1 a perspective view of the system according to a preferred embodiment of the present invention in front open view, is disclosed. The system is shown in an assembled operational state and comprises a left monitor 11, a 1080p webcam 13, a camera power button.

14, a hinge 15, 1394a firewire input 16, ESATA input 17, headphone output 18, microphone input 19, Ethernet 7.1 audio output 20 and on the right monitor 12, an RGB output 21, S/PDIF output 22, HDMI output 23, Serial ATA 24, USB 3.0 input 25, USB 3.0 input 26, DC Input 27, and computer power switch 28.

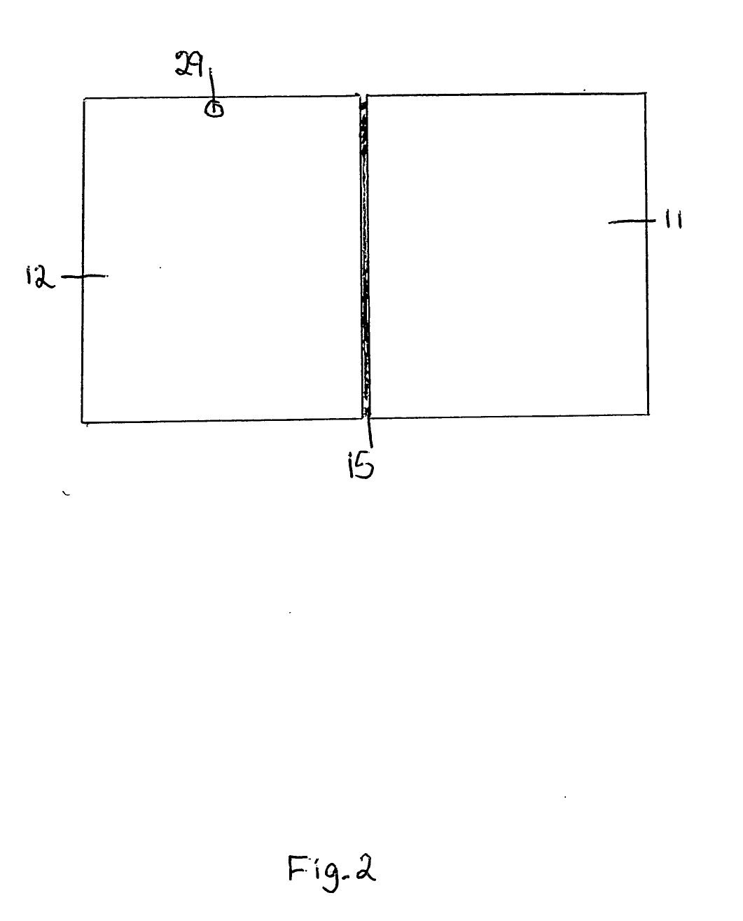

Referring to FIG. 2, a perspective view of the system according to a preferred embodiment of the present invention in back open view, is disclosed. The system is shown in an assembled operational state and comprises a left monitor 11, a 1080p webcam 29; a hinge 15, and a right monitors 12.

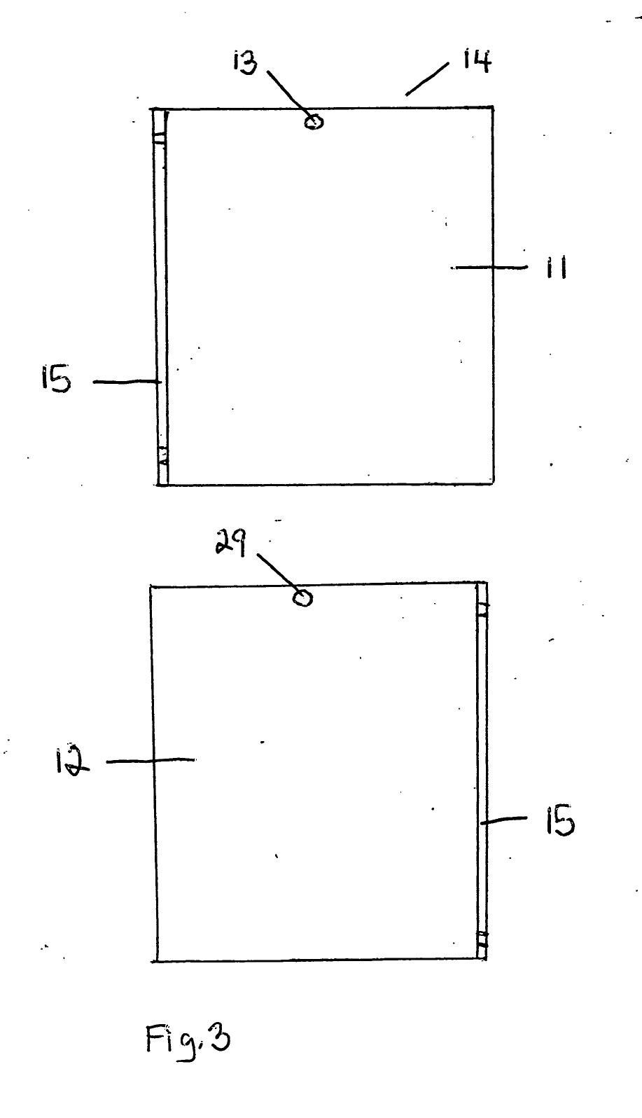

Referring to FIG. 3, a perspective view of the system according to a preferred embodiment of the present invention in front and back closed view, is disclosed The system is shown in an assembled operational state and comprises a left monitor 11, a 1080p webcam 13, a camera power button 14, a hinge 15, and right monitor 12, a 1080p webcam 29.

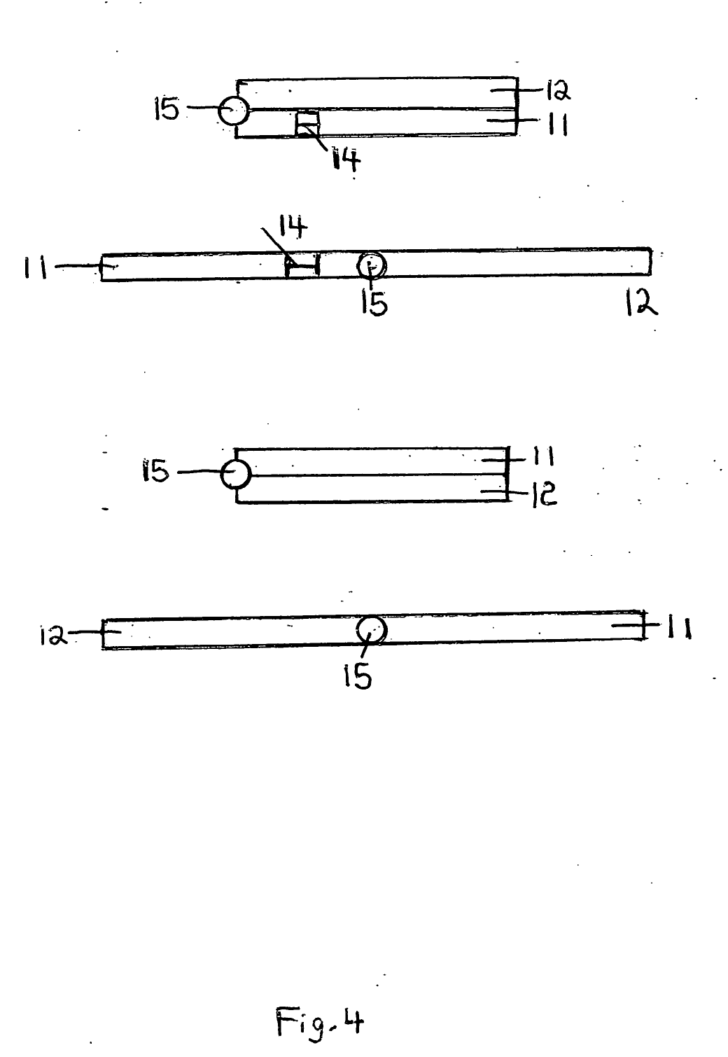

Referring to FIG. 4, a perspective View of the system according to a preferred embodiment of the present invention in top closed and open view also a bottom closed and open view comprised of hinge 15, a camera power button 14, left monitor Hand right monitor 12, is disclosed.

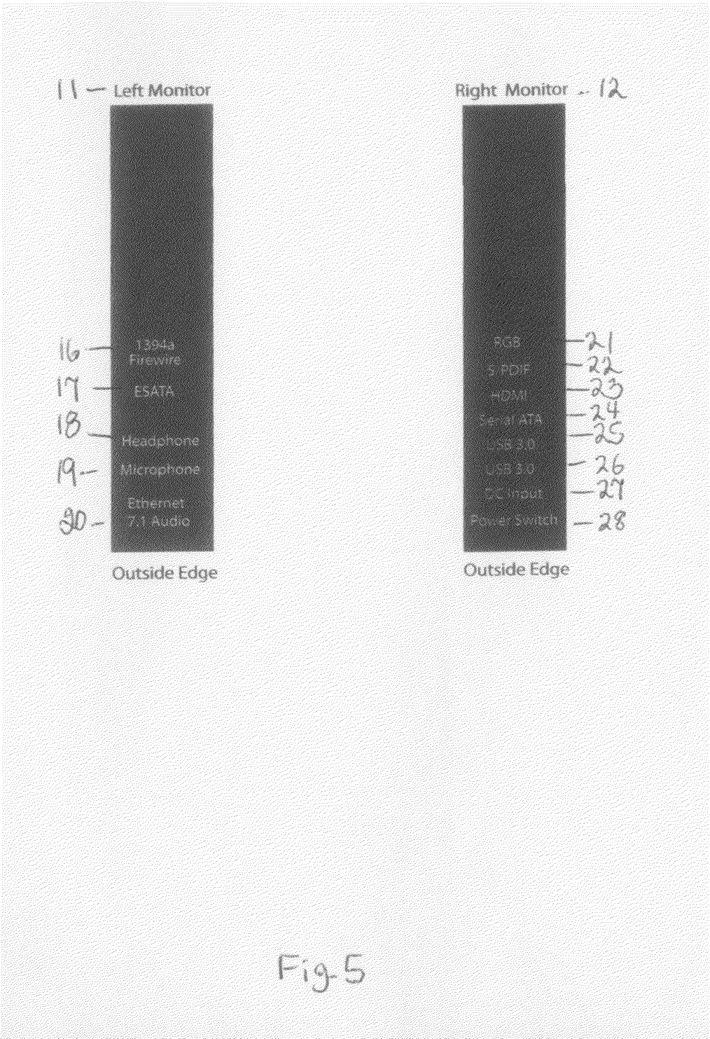

Referring to FIG. 5, a perspective view of the system according to a preferred embodiment of the present invention the left monitor 11 and right monitor 12 outside edge view with its inputs and outputs on the left monitor: 1394a Firewire input 16, ESATA input 17, headphone output 18, microphone input 19, Ethernet 7.1 audio output 20 and on the right monitor 12, an RGB output 21, S/PDIF output 22, HDMI output 23, Serial ATA 24, USB 3.0 input 25, USB 3.0 input 26, DC Input 27, and computer power switch 28

I claim:

1. A computer system, comprising:
and a processing unit with two monitors sharing the internal computer processors, central processing unit, hard drives, video card, ram, and other internals as needed;
a portable computer monitor further comprising a plurality of user interface features and a processing unit;
a top monitor in electrical communication with said processing unit and, a bracket hinge comprising:
a lower hinge connection connected to a central portion of the rear upper edge of the monitor, wherein the hinge is intercalated between front and rear sides of both monitors;

2. The system of claim 1, further comprising a ribbon cable:
a first connection removably attachable to said processing unit of said computer; and,
a second connection removably attachable to said display of said monitors;
wherein said ribbon cable is fully enclosed within said monitor cover, said bracket, and said portable computer;
wherein said ribbon cable further comprises a suitable connection of control to the second monitor.

3. A computer system, comprising:
a portable computer, with shared components by both monitors further comprising a plurality of user-interface features a pair of monitors in electrical communication with said processing unit;
wherein a bracket hinge comprising:
a lower hinge connection hingedly connected to a central portion of a rear upper edge of said portable computer monitor; and,
wherein said bracket hinge is intercalated between front and rear sides of said monitors.

4. The system of claim 1 wherein further comprising a ribbon cable:
a first connection removably attachable to said processing unit of said portable computer monitor and,
a second connection removably attachable to said display of said monitor;
wherein said ribbon cable is fully enclosed within said monitor cover, said bracket hinge, and said portable computer monitor.
